(19) United States
(12) Patent Application Publication
(10) Pub. No.: US 2025/0117602 A1
(43) Pub. Date: Apr. 10, 2025

(54) LARGE MODEL-BASED RECOMMENDATION METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Zhaoxu Wang, Beijing (CN); Qiang Xie, Beijing (CN); Yuhang Zheng, Beijing (CN); Shouke Qin, Beijing (CN); Zonggang Wu, Beijing (CN); Yuanhua Shao, Beijing (CN); Yan Wang, Baotou (CN); Ruohan Chang, Beijing (CN); Qingqing Wu, Beijing (CN); Lu Wang, Beijing (CN); Songge Guo, Beijing (CN); Chang Li, Beijing (CN); Xi Cao, Beijing (CN); Qian Wu, Beijing (CN); Xiaoyu Hu, Beijing (CN); Huijie Liu, Beijing (CN); Yu Guo, Beijing (CN); Hui Xue, Beijing (CN); Rufeng Cheng, Beijing (CN)

(73) Assignee: BEIJING BAIDU NETCOM SCIENCE TECHNOLOGY CO., LTD., Beijing (CN)

(21) Appl. No.: 18/988,044

(22) Filed: Dec. 19, 2024

(30) Foreign Application Priority Data
Sep. 13, 2024 (CN) 202411288399.8

(51) Int. Cl. G06F 40/40

(52) U.S. Cl. CPC G06F 40/40

(57) ABSTRACT

A large model-based recommendation method includes: determining description information of interested content corresponding to a target user; inputting a content to be recommended, the description information of interested content and current popular search sentences into a large model to generate at least one recommendation card corresponding to the content to be recommended, in which the recommendation card contains a recommendation word associated with the content to be recommended; obtaining a current behavior characteristic of the target user; and in response to the current behavior characteristic satisfying a display condition of the recommendation card, displaying the recommendation card corresponding to at least one content to be recommended.

### CROSS-REFERENCE TO RELATED APPLICATION

The present application claims priority to and benefits of Chinese Patent Application Serial No. 202411288399.8, filed on Sep. 13, 2024, the entire content of which is incorporated herein by reference.

### TECHNICAL FIELD

The disclosure relates to a field of computer technologies, in particular to a field of artificial intelligence technologies such as deep learning, intelligent recommendation, large model and the like, especially to a large model-based recommendation method, a large model-based recommendation apparatus, an electronic device and a storage medium.

### BACKGROUND

With the rapid development of the Internet, various information flow products have emerged. The information flow products distribute content products in the form of waterfall flows. The common information flow products may be, for example, shopping applications, whose content products distributed correspondingly are commodities; and news applications, whose content products distributed correspondingly are news information, etc.

However, the current recommendation systems mostly use fixed sentences to recommend contents, the manner of which is single, leading to the problems of poor recommendation effect and low accuracy.

### SUMMARY

According to a first aspect of the disclosure, a large model-based recommendation method is provided. The method includes:
determining description information of interested content corresponding to a target user;
inputting a content to be recommended, the description information of interested content and current popular search sentences into a large model to generate at least one recommendation card corresponding to the content to be recommended, wherein the recommendation card contains a recommendation word associated with the content to be recommended;
obtaining a current behavior characteristic of the target user; and
in response to the current behavior characteristic satisfying a display condition of the recommendation card, displaying the recommendation card corresponding to at least one content to be recommended.

According to a second aspect of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to execute the large model-based recommendation method as described in the first aspect.

Accord to a third aspect of the disclosure, a non-transitory computer-readable storage medium having computer instructions stored thereon is provided. The computer instructions are used to cause the computer to execute the large model-based recommendation method as described in the first aspect.

### BRIEF DESCRIPTION OF THE DRAWINGS

The attached drawings are for better understanding this scheme and do not constitute a limitation of this disclosure.

FIG. 1 is a flowchart of a large model-based recommendation method according to an embodiment of the disclosure.

FIG. 2 is a flowchart for determining description information of interested content according to an embodiment of the disclosure.

FIG. 3 is a schematic diagram of a recommendation card according to an embodiment of the disclosure.

FIG. 4 is a schematic diagram of a recommendation card according to an embodiment of the disclosure.

FIG. 5 is a flowchart of a large model-based recommendation method according to another embodiment of the disclosure.

FIG. 6 is a flowchart of a large model-based recommendation method according to yet another embodiment of the disclosure.

FIG. 7 is a flowchart of a large model-based recommendation method according to yet another embodiment of the disclosure.

FIG. 8 is a structural diagram of a click rate prediction model according to an embodiment of the disclosure.

FIG. 9 is a schematic diagram of a display interface according to an embodiment of the disclosure.

FIG. 10 is a schematic diagram of a follow-up content according to an embodiment of the disclosure.

FIG. 11 is a flowchart of a large model-based recommendation method according to yet another embodiment of the disclosure.

FIG. 12 is a schematic diagram of a large model-based recommendation apparatus according to an embodiment of the disclosure.

FIG. 13 is a block diagram of an electronic device for implementing a large model-based recommendation method according to the embodiment of the disclosure.

### DETAILED DESCRIPTION

Exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following description.

The disclosure relates to the field of artificial intelligence (AI) technologies such as deep learning, intelligent recommendation, large model, etc.

Artificial Intelligence (AI), as a new technical science, studies and develops theories, methods, technologies and application systems for simulating, extending and expanding human intelligence.

Deep Learning (DL) is to learn inherent laws and representation levels of sample data, and information obtained in these learning processes is of great help to interpretation of data such as words, images and sounds. The ultimate goal of DL is to enable machines to have analytical learning ability like human beings, to recognize data such as words, images and sounds.

Intelligent recommendation is an important means of information filtering and custom services, the core of the intelligent recommendation is to automatically analyze and predict potential needs or points of interest of users via an algorithm model by integrating multi-dimensional information such as historical behavior data and interest preferences of users and contextual environment, and then recommend contents, goods, services or social relationships that the users may be interested in.

Large model may also be called as a foundation model, which can extract knowledge through billion-level corpora or images, and learn to produce a large model with billion-level parameters.

In the technical scheme of this disclosure, the collection, storage, use, processing, transmission, provision and disclosure of personal information of users all comply with the provisions of relevant laws and regulations, and do not violate public order and good customs.

A large model-based recommendation method, a large model-based recommendation apparatus, an electronic device and a storage medium of the embodiment of the disclosure are described below with reference to the attached drawings.

It should be noted that the executive body of the large model-based recommendation method in this embodiment is the large model-based recommendation apparatus. The apparatus can be implemented by software and/or hardware, and can be configured into an electronic device. The electronic device may include, but is not limited to a terminal, a server and the like.

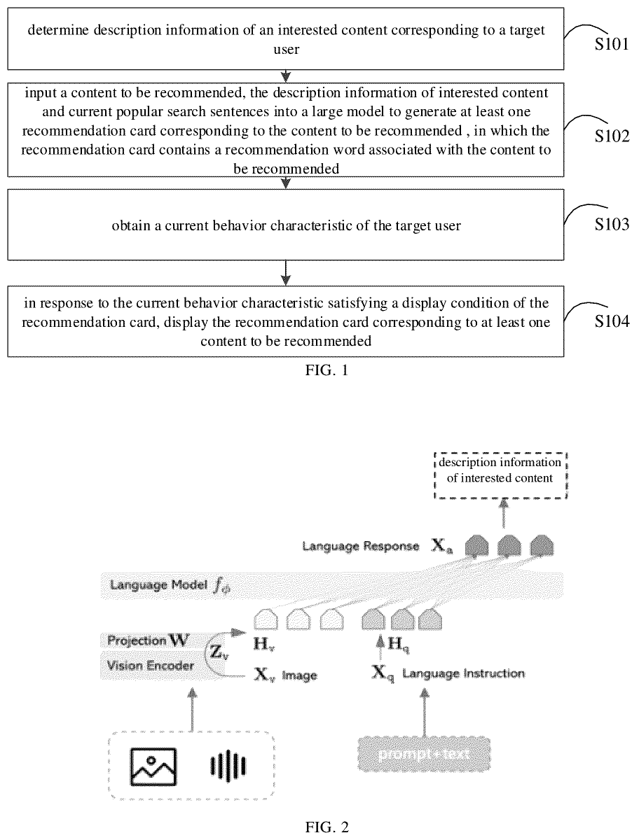

FIG. 1 is a flowchart of a large model-based recommendation method according to an embodiment of the disclosure.

As illustrated in FIG. 1, the large model-based recommendation method includes the following steps.

At step S101, description information of interested content corresponding to a target user is determined.

The target user can be a user that expects a content to be recommended.

The descriptive information of interested content can include a type (such as sports, music, entertainment, etc.) of the interested content, and an emotional classification (for example, happy, moving, etc.) of the interested content.

In some embodiments, the description information of interested content corresponding to the target user is determined based on a portrait of the target user and a historical consumption content.

In some embodiments, the portrait of the target user can be generated according to the user's age, gender, and points of interest, etc.

In the technical scheme of the disclosure, the collection, storage, use, processing, transmission, provision and disclosure of private information such as the user's age, gender and points of interest are being done with the user's consent, all of which comply with the provisions of relevant laws and regulations and do not violate public order and good customs.

The historical consumption content can be a title, a content, a classification, a cover picture, a video, etc. corresponding to resources that the target user has interacted with and have a high degree of completion.

In some embodiments, the portrait of the target user, the historical consumption content and prompts can be input into the large model, and the large model captures the description information of interested content of the target user.

FIG. 2 is a flowchart for determining description information of interested content according to an embodiment of the disclosure. As illustrated in FIG. 2, firstly, texts and prompts associated with the historical consumption content are encoded by a language instruction encoder to obtain a text feature Hq. The information of images, videos and other modalities associated with the historical consumption content is encoded by a vision encoder, and then projected to an embedding feature space of the large model to obtain a visual feature Hv, realizing a feature alignment of different modalities. Finally, the text feature Hq and the visual feature Hv are input into the large model (which may be a language model) to obtain a vector Xa of a large model response, so that the description information of interested content corresponding to the target user is obtained.

At step S102, a content to be recommended, the description information of interested content and current popular search sentences are input into a large model to generate at least one the recommendation card corresponding to the content to be recommended, in which the recommendation card contains a recommendation word associated with the content to be recommended.

The content to be recommended may be a content to be recommended to the user. There may be one or more contents to be recommended, which is not limited in the disclosure.

The current popular search sentences can be sentences with high search volumes.

In some embodiments, the recommendation card may also include a cover content matching the recommendation word, such as a picture, a video or the like.

In some embodiments, the recommendation word corresponding to the content to be recommended can be generated based on the content to be recommended, the description information of interested content and the current popular search sentences, and then the recommendation card can be generated based on the recommendation word.

The large model used to generate the recommendation card corresponding to the content to be recommended and the large model used to determine the description information of interested content can be the same large model or different large models, which is not limited in the disclosure.

At step S103, a current behavior characteristic of the target user is obtained.

The current behavior characteristic of the target user can be, for example, a behavior of the target user browsing a displayed content in a display interface, a behavior of the target user clicking on the displayed content, a length of time of the target user spent on viewing the displayed content, and a behavior of the target user continuously sliding the display interface, which is not limited in the disclosure.

At step S104, in response to the current behavior characteristic satisfying a display condition of the recommendation card, the recommendation card corresponding to at least one content to be recommended is displayed.

In some embodiments, the display condition may include the target user clicking on the displayed content frequently, staying for a long time, sliding, turning pages frequently, and no clicks, etc.

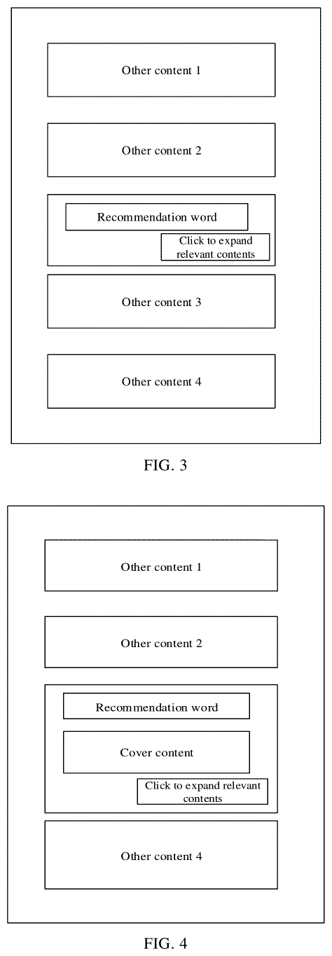

FIG. 3 is a schematic diagram of a recommendation card according to an embodiment of the disclosure. As illustrated in FIG. 3, a display interface includes a recommendation card and other contents besides recommendation card. The recommendation card includes a recommendation word and guidance information (such as, click to expand relevant contents for you).

FIG. 4 is a schematic diagram of a recommendation card according to an embodiment of the disclosure. As illustrated in FIG. 4, a display interface includes the recommendation card and other contents besides recommendation card. The recommendation card includes a recommendation word, a cover content and guidance information (such as, click to expand relevant contents for you).

In the embodiment of the disclosure, the description information of interested content corresponding to the target user is determined firstly, and then the content to be recommended, the description information of interested content and the current popular search sentences are input into the large model to generate at least one recommendation card corresponding to the content to be recommended. The current behavior characteristic of the target user is then obtained, and when the current behavior characteristic satisfies the display condition of the recommendation card, the recommendation card corresponding to at least one content to be recommended is displayed. Therefore, for the same content to be recommended, different recommendation cards can be generated for different users in combination with the description information of interested content of different users and the popular search sentences, so that the generated recommendation cards are more likely to comply with user preferences, and the recommendation card can be displayed for the user according to the user's current behavior, which improves a diversity and an accuracy of recommendation ways.

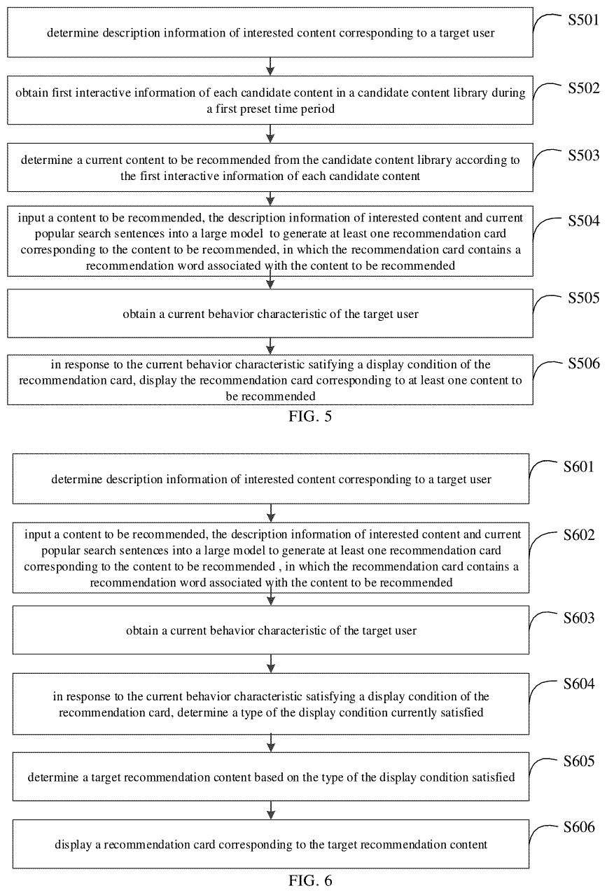

FIG. 5 is a flowchart of a large model-based recommendation method according to another embodiment of the disclosure. As illustrated in FIG. 5, the large model-based recommendation method includes the following steps.

At step S501, description information of interested content corresponding to a target user is determined.

At step S502, first interactive information of each candidate content in a candidate content library during a first preset time period is obtained.

The candidate contents in the candidate content library can be contents that have already been displayed on a platform.

The first preset time period may be one week, one month, one day, etc., which is not limited in the disclosure.

The first interactive information can be browsing, clicking, feedback and other behaviors performed by other users on the candidate content.

At step S503, a current content to be recommended is determined from the candidate content library according to the first interactive information of each candidate content.

In the embodiment of the disclosure, according to the first interactive information, the candidate content with more interaction can be determined as the content to be recommended, and recommended to the target user, which improves a probability of the target user clicking on the recommendation card, thereby improving a recommendation accuracy.

In some embodiments, a score of each candidate content can be comprehensively determined according to the first interactive information, and the candidate content with a higher score can be determined as the content to be recommended. In some embodiments, the more clicks on the candidate content, the higher the score, and the more users interested in the candidate content, the higher the score.

At step S504, a content to be recommended, the description information of interested content and current popular search sentences are input into a large model, and at least one recommendation card corresponding to the content to be recommended is generated, in which the recommendation card contains a recommendation word associated with the content to be recommended.

At step S505, a current behavior characteristic of the target user is obtained.

At step S506, in response to the current behavior characteristic satisfying a display condition of the recommendation card, the recommendation card corresponding to at least one content to be recommended is displayed.

The specific implementations of steps S504-S506 can be referred to the implementations described in detail in other embodiments of the disclosure, and will not be described in detail here.

In the embodiment of the disclosure, the first interactive information of each candidate content in the candidate content library during the first preset time period is obtained, and then the content to be recommended is determined from the candidate content library according to the first interactive information of each candidate content. The content to be recommended, the description information of interested content and the current popular search sentences are input into the large model to generate at least one recommendation card corresponding to the content to be recommended. When the current behavior characteristic of the target user satisfies the display condition of the recommendation card, the recommendation card corresponding to at least one content to be recommended is displayed. Therefore, the content to be recommended can be determined according to the first interactive information of each candidate content, so that popular candidate contents can be recommended to the target user, and then the popular contents can be presented to different users in different recommendation ways. In this way, the generated recommendation card corresponding to the popular content is more likely to comply with user preferences, thereby further improving the recommendation accuracy.

FIG. 6 is a flowchart of a large model-based recommendation method according to yet another embodiment of the disclosure. As illustrated in FIG. 6, the large model-based recommendation method includes the following steps.

At step S601, description information of interested content corresponding to a target user is determined.

At step S602, a content to be recommended, the description information of interested content and current popular search sentences are input into a large model, and at least one recommendation card corresponding to the content to be recommended is generated, in which the recommendation card contains a recommendation word associated with the content to be recommended.

At step S603, a current behavior characteristic of the target user is obtained.

The specific implementations of steps S601-S603 can be referred to the implementations described in detail in other embodiments of the disclosure, and will not be described in detail here.

At step S604, in response to the current behavior characteristic satisfying a display condition of the recommendation card, a type of the display condition that is currently satisfied is determined.

In some embodiments, the type of the display condition may include a first type and a second type.

In some embodiments, the first type means that a behavioral characteristic is positive and proactive, such as clicking frequently, staying for a long period time, etc. The second type means that a behavior characteristic is negative and pessimistic, such as sliding, turning pages frequently, no clicking behavior, etc.

At step S605, a target recommendation content is determined based on the type of the display condition satisfied.

In some embodiments, in a case where the display condition satisfied is the first type, the target recommendation content is determined based on a content currently consumed by the target user.

It should be noted that in the case where the display condition that the behavior characteristic of the target user satisfies is the first type, it means that the target user is more interested in the content currently consumed, so that the target recommendation content associated with the content currently consumed can be selected from the content to be recommended according to the content currently consumed. Therefore, the recommendation content that is finally displayed is more in line with the current interest of the target user, which improves a probability of the target user clicking on the displayed recommendation card, thereby improving the recommendation accuracy.

In some embodiments, in the case where the display condition that the behavior characteristic of the target user satisfies is the first type, the content to be recommended that belongs to the same type as the currently consumed content can be determined as the target recommendation content.

For example, when the currently consumed content belongs to a music type, the content to be recommended of the music type is determined as the target recommendation content.

In some embodiments, in the case where the display condition that the behavior characteristic of the target user satisfies is the first type, the content to be recommended whose similarity with the currently consumed content is greater than a first threshold is determined as the target recommendation content.

In some embodiments, the similarity between the content to be recommended and the currently consumed content can be determined by pre-similarity, Euclidean distance and other methods.

In the embodiment of the disclosure, the content to be recommended that has a strong correlation with the currently consumed content can be determined as the target recommendation content according to the type of the currently consumed content and the similarity with the currently consumed content, which not only improves the probability of the target user clicking on the target recommendation content, thereby improving the recommendation accuracy, but also improves a diversity of information associated with the currently consumed content.

In some embodiments, in a case where the display condition satisfied is the second type, the target recommendation content is determined based on a content currently displayed on a display interface.

It should be noted that in a case where the display condition that the behavior characteristic of the target user satisfies is the second type, it means that the target user is not interested in the content currently displayed in the interface, so that a target consumption content that is unassociated with the currently displayed content can be selected from the content to be recommended according to the currently displayed content, and other contents that may be of interest to the target user can be recommended, which improves the probability of the target user clicking on the displayed recommendation card, thereby further improving the recommendation accuracy.

In some embodiments, in a case where the display condition that the behavior characteristic of the target user satisfies is the second type, the content to be recommended whose similarity with the currently displayed content is less than a second threshold is determined as the target recommendation content.

In some embodiments, the second threshold is less than or equal to the first threshold.

In some embodiments, in a case where the display condition that the behavior characteristic of the target user satisfies is the second type, the content to be recommended that does not belong to the same type as the currently displayed content is determined as the target recommendation content.

For example, when the currently displayed content belongs to a music type, the content to be recommended that does not belong to the music type is determined as the target recommendation content.

In the embodiment of the disclosure, the content to be recommended that is unassociated with the currently consumed content can be determined as the target recommendation content according to the type of the currently displayed content and the similarity with the currently displayed content, so that the target recommendation content that is of interest to the target user can be provided to the target user as much as possible, which further improves the recommendation accuracy.

At step S606, a recommendation card corresponding to the target recommendation content is displayed.

In the embodiment of the disclosure, the content to be recommended, the description information of interested content and the current popular search sentences are input into the large model to generate at least one recommendation card corresponding to the content to be recommended. The recommendation card contains the recommendation word associated with the content to be recommended. In a case where the current behavior characteristic of the target user satisfies the display condition of the recommendation card, the type of the display condition satisfied currently is determined. The target recommendation content is determined based on the type of the display condition satisfied. Finally, the recommendation card corresponding to the target recommendation content is displayed. Therefore, according to the type of the display condition satisfied by the current behavior characteristic of the target user, the target recommendation content that the user may be more interested in at present can be determined, which further improves the recommendation accuracy.

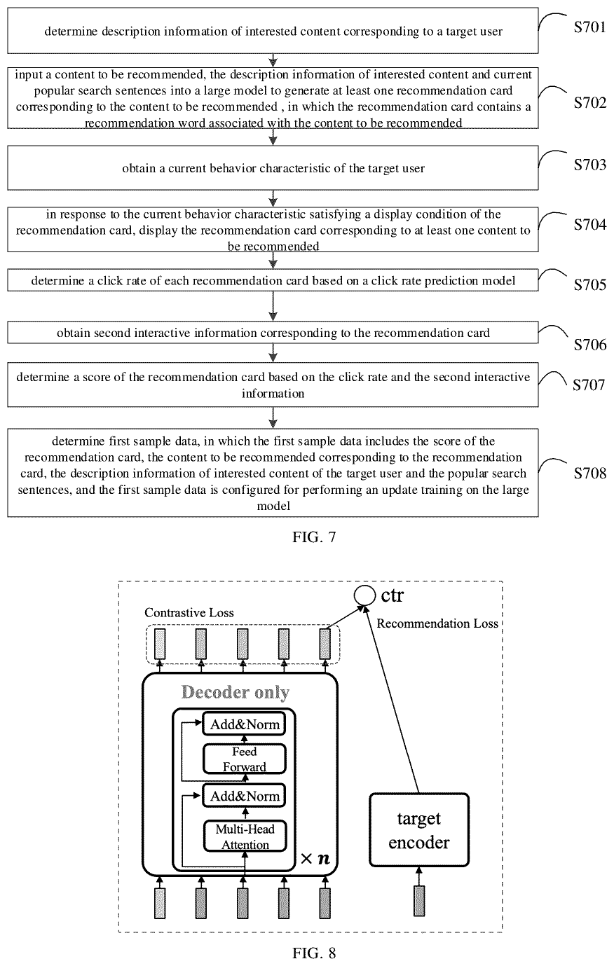

FIG. 7 is a flowchart of a large model-based recommendation method according to an embodiment of the disclosure. As illustrated in FIG. 7, the large model-based recommendation method includes the following steps.

At step S701, description information of interested content corresponding to a target user is determined.

At step S702, a content to be recommended, the description information of interested content and current popular search sentences are input into a large model, and at least one recommendation card corresponding to the content to be recommended is generated, in which the recommendation card contains a recommendation word associated with the content to be recommended.

At step S703, a current behavior characteristic of the target user is obtained.

At step S704, in response to the current behavior characteristic satisfying a display condition of the recommendation card, the recommendation card corresponding to at least one content to be recommended is displayed.

The specific implementations of steps S701-S704 can be referred to the implementations described in detail in other embodiments of the disclosure, and will not be described in detail here.

At step S705, a click rate of each recommendation card is determined based on a click rate prediction model.

The click rate prediction model can be a Reward model, and the structure of the click rate prediction model can be Decoder-only Transformer structure.

In some embodiments, the click rate is obtained by inputting the recommendation word in the recommendation card, an behavior sequence of the target user during a second preset time period and a portrait of the target user into the click rate prediction model. Therefore, the click rate of the target user on the recommendation card can be pre-estimated more accurately in combination with the portrait and behavior information of the target user.

In some embodiments, FIG. 8 is a schematic diagram of a click rate prediction model provided by an embodiment of the disclosure. As illustrated in FIG. 8, the method for training a click rate prediction model includes: obtaining training data, in which the training data includes a recommendation word sample, a user portrait sample, a sample of a user historical behavior sequence and a click rate tag; obtaining a predicted click rate and a predicted behavior sequence corresponding to the historical behavior sequence by inputting the recommendation word sample, the user portrait sample, the sample of the user historical behavior sequence and the click rate tag into a click rate prediction model to be trained; and according to a recommendation loss between the predicted click rate and the click rate tag, and a contrastive loss between the historical behavior sequence and the predicted behavior sequence, determining a target loss to train the click rate prediction model.

According to the first i behaviors in the historical behavior sequence, the (i+1)^{th} behavior can be predicted, to obtain the predicted behavior sequence. In some embodiments, a masked-transformer can be used to mask behaviors other than the first i behaviors, and thus the (i+1)^{th} behavior can be predicted according to the first i behaviors in the historical behavior sequence.

The second preset time period may be a time period before the current time.

The behavior sequence corresponding to the second preset time period can be clicking, feedback and browsing behaviors of the target user on the content during the second preset time period.

In some embodiments, third sample data is determined. The third sample data includes clicked information corresponding to the recommendation card and consumed information of a follow-up content of the recommendation card. The third sample data is configured for performing an update training on the click rate prediction model. Therefore, the click rate prediction model can be updated according to the clicked information of the target user on the recommendation card and the consumed information of the follow-up content, which can improve an accuracy of the click rate prediction model in predicting the click rate.

At step S706, second interactive information corresponding to the recommendation card is obtained.

In some embodiments, the second interactive information corresponding to the recommendation card is determined according to the clicked information corresponding to the recommendation card and the consumed information of the follow-up content of the recommendation card. The follow-up content is a content displayed after clicking the recommendation card. Therefore, more comprehensive interactive information can be provided for accurately determining the score of the recommendation card in combination with the interactive information including a click situation of the recommendation card and the consumed information of follow-up content, which improves an accuracy of determining the score of the recommendation card.

The clicked information corresponding to the recommendation card may include click information of the target user on the recommendation card, and may also include a number of times the recommendation card has been clicked by other users. Alternatively, the clicked information corresponding to the recommendation card may also include a ratio of a number of times the recommendation card has been clicked to a number of recommendation times.

The consumed information of the follow-up content of the recommendation card may include consumption information of the target user on the follow-up content or consumption information of other users on the follow-up content, which is not limited in the disclosure.

FIG. 9 is a schematic diagram of a display interface provided by an embodiment of the disclosure. As illustrated in FIG. 9, when the recommendation card in FIG. 3 or FIG. 4 is clicked, wait information can be displayed in the display interface, for example, “fresh content is about to be presented to you”.

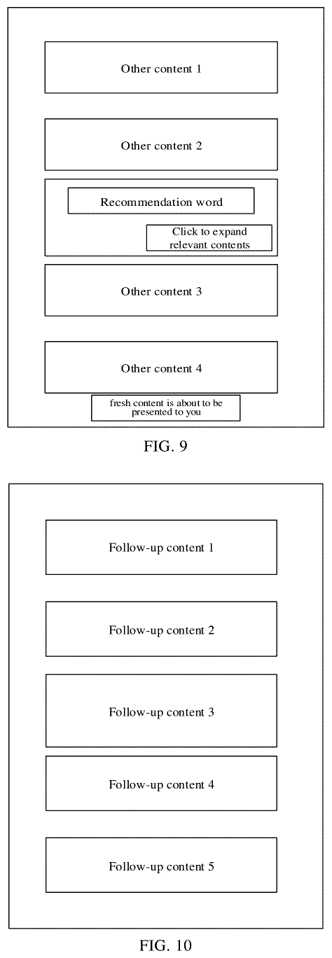

FIG. 10 is a schematic diagram of a follow-up content according to an embodiment of the disclosure. As illustrated in FIG. 10, after the recommendation card is clicked, the display interface is refreshed, and a follow-up content 1 and a follow-up content 2 associated with the recommendation word are displayed.

At step S707, a score of the recommendation card is determined based on the click rate and the second interactive information.

In some embodiments, the higher the click rate, the higher the score, and the greater the ratio of the number of click times to the number of recommendation times, which is indicated by the clicked information corresponding to the recommendation card, the higher the score. The better the quality of the follow-up content indicated by the consumed information of the follow-up content of the recommendation card, the higher the score.

In some embodiments, in a case where the second interactive information includes the consumed information of the follow-up content, a correlation between a follow-up resource and a recommendation word can be determined first based on the consumed information of the follow-up content. Based on the consumed information of the follow-up content and the correlation between the follow-up resource and the recommendation word, a quality of the follow-up resource is then evaluated, and then the score of the recommendation card is comprehensively analyzed in combination with the click rate, an evaluation of the follow-up resource and the clicked information corresponding to the recommendation card.

In some embodiments, the follow-up content clicked by the user can be taken as a positive sample, and the follow-up content that has not been clicked can be taken as a negative sample. A third model can be fine-tuned through contrastive learning, to evaluate the correlation between the follow-up resource and the recommendation word. The correlation between the follow-up resource and the recommendation word can be then determined through the third model.

At step S708, first sample data is determined, in which the first sample data includes the score of the recommendation card, the content to be recommended corresponding to the recommendation card, the description information of interested content of the target user and the popular search sentences, and the first sample data is configured for performing an update training on the large model.

In the embodiment of the disclosure, after determining the score corresponding to the recommendation card, the update training can be performed on the large model based on the score of the recommendation card, the content to be recommended corresponding to the recommendation card, the description information of interested content of the target user and the popular search sentences, so that performances of the large model can be improved, and the recommendation card that the target user is more interested in can be generated in the subsequent recommendation task, improving the recommendation accuracy.

In the embodiment of the disclosure, after displaying the recommendation card corresponding to at least one content to be recommended, the click rate of each recommendation card can be determined based on the click rate prediction model. The second interactive information corresponding to the recommendation card can be obtained, and the score of the recommendation card can be determined based on the click rate and the second interactive information. Finally, the first sample data can be determined, and the first sample data includes the score of the recommendation card, the content to be recommended corresponding to the recommendation card, the description information of interested content of the target user and the popular search sentences. The first sample data is configured for performing an update training on the large model. Therefore, the quality of the recommendation card can be comprehensively determined according to the predicted click rate of the recommendation card and the real interactive information of the recommendation card, and then the large model can be guided to update based on the quality of the recommendation card, the content to be recommended corresponding to the recommendation card, the description information of interested content of the target user and the popular search sentences, so that the performances of the large model can be improved, and the recommendation card that the target user is more interested in can be generated in the subsequent recommendation task, improving the recommendation accuracy.

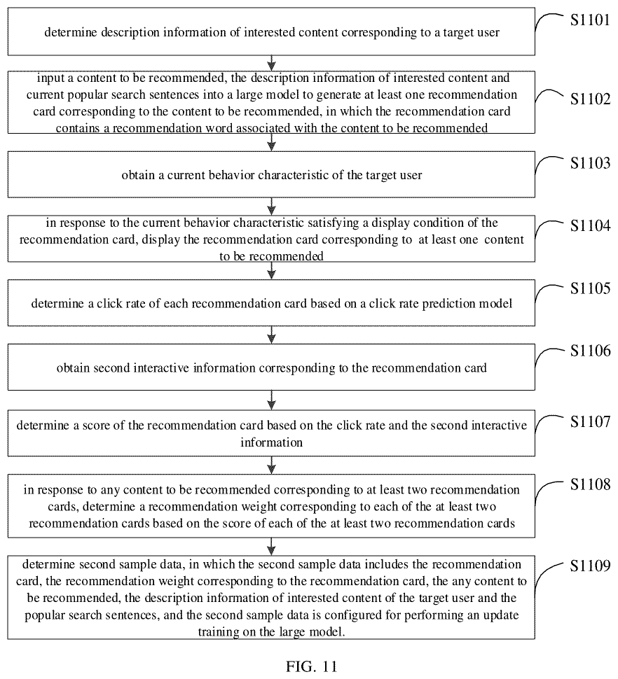

FIG. 11 is a flowchart of a large model-based recommendation method according to another embodiment of the disclosure. As illustrated in FIG. 11, the large model-based recommendation method includes the following steps.

At step S1101, description information of interested content corresponding to a target user is determined.

At step S1102, a content to be recommended, the description information of interested content and current popular search sentences are input into a large model, and at least one recommendation card corresponding to the content to be recommended is generated, in which the recommendation card contains a recommendation word associated with the content to be recommended.

At step S1103, a current behavior characteristic of the target user is obtained.

At step S1104, in response to the current behavior characteristic satisfying a display condition of the recommendation card, the recommendation card corresponding to at least one content to be recommended is displayed.

At step S1105, a click rate of each recommendation card is determined based on a click rate prediction model.

At step S1106, second interactive information corresponding to the recommendation card is obtained.

At step S1107, a score of the recommendation card is determined based on the click rate and the second interactive information.

The specific implementations of steps S1101-S1107 can be referred to the implementations described in detail in other embodiments of the disclosure, and will not be described in detail here.

At step S1108, in response to any content to be recommended corresponding to at least two recommendation cards, a recommendation weight corresponding to each of the at least two recommendation cards is determined based on the score of each of the at least two recommendation cards.

In some embodiments, at least two recommendation cards are generated for the same content to be recommended, and the recommendation word in each recommendation card is different.

In some embodiments, the higher the score of the recommendation card, the higher the recommendation weight.

At step S1109, second sample data is determined, in which the second sample data includes the recommendation card, the recommendation weight corresponding to the recommendation card, the any content to be recommended, the description information of interested content of the target user and the popular search sentences, and the second sample data is configured for performing an update training on the large model.

In the embodiment of the disclosure, after determining the recommendation weight corresponding to the recommendation card, the update training can be performed on the large model based on any content to be recommended, the recommendation card corresponding to the any content to be recommended, the recommendation weight corresponding to the recommendation card, the description information of interested contents of the target user and the popular search sentences, so that the large model can learn the recommendation weight corresponding to the recommendation card corresponding to the any content to be recommended, and then when the any content to be recommended is recommended again, the recommendation card with higher recommendation weight can be displayed firstly to the user, which improves the recommendation accuracy.

In the embodiment of the disclosure, after displaying the recommendation card corresponding to at least one content to be recommended, the click rate of each recommendation card can be determined based on the click rate prediction model. The second interactive information corresponding to the recommendation card can be obtained, and the score of the recommendation card can be determined based on the click rate and the second interactive information. In response to the any content to be recommended corresponding to at least two recommendation cards, the recommendation weight corresponding to each of the at least two recommendation cards is determined based on the score of each of the at least two recommendation cards. Finally, the second sample data is determined, in which the second sample data includes the recommendation card, the recommendation weight corresponding to the recommendation card, any content to be recommended, the description information of interested content of the target user and the popular search sentences, and the second sample data is configured for performing an update training on the large model. Therefore, the recommendation weight of the recommendation card can be determined according to the score of the recommendation card, and the large model can be guided to learn the recommendation weight corresponding to the recommendation card under any content to be recommended, so that when the any content to be recommended is recommended again, the recommendation card with higher recommendation weight can be displayed firstly to the user, which improves the recommendation accuracy.

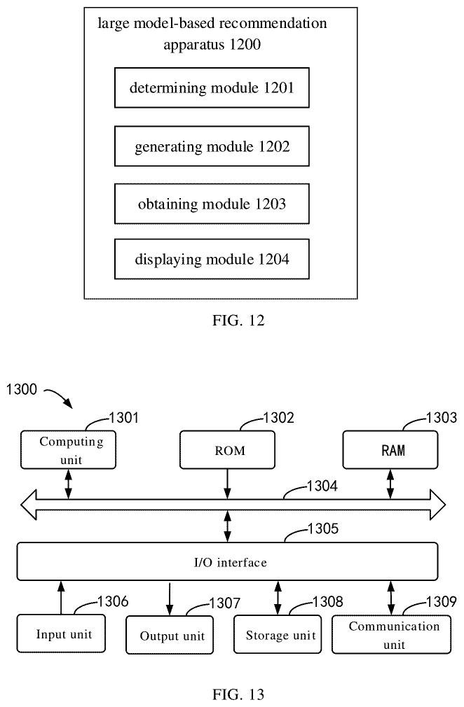

FIG. 12 is a schematic diagram of a large model-based recommendation apparatus according to an embodiment of the disclosure.

As illustrated in FIG. 12, a large model-based recommendation apparatus 1200 includes:
a determining module 1201, configured to determine description information of interested content corresponding to a target user;
a generating module 1202, configured to input a content to be recommended, the description information of interested content and current popular search sentences into a large model to generate at least one recommendation card corresponding to the content to be recommended, wherein the recommendation card contains a recommendation word associated with the content to be recommended;
an obtaining module 1203, configured to obtain a current behavior characteristic of the target user; and
a displaying module 1204, configured to, in response to the current behavior characteristic satisfying a display condition of the recommendation card, display the recommendation card corresponding to at least one content to be recommended.

In some embodiments of the disclosure, the apparatus also includes: a first processing module. The first processing module is configured to:
obtain first interactive information of each candidate content in a candidate content library during a first preset time period; and
determine a content to be recommended from the candidate content library according to the first interactive information of each candidate content.

In some embodiments of the disclosure, the displaying module 1204 is configured to:
in response to the current behavior characteristic satisfying the display condition of the recommendation card, determine a type of the display condition satisfied currently;
determine a target recommendation content based on the type of the display condition satisfied; and
display a recommendation card corresponding to the target recommendation content.

In some embodiments of the disclosure, the displaying module 1204 is configured to:
in response to the type of the display condition being a first type, determine the target recommendation content based on a content currently consumed by the target user; or,
in response to the type of the display condition being a second type, determine the target recommendation content based on a content currently displayed on a display interface.

In some embodiments of the disclosure, the displaying module 1204 is configured to:
determine a content to be recommended belonging to the same type as the currently consumed content as the target recommendation content; or,
determine a content to be recommended whose similarity with the currently consumed content is greater than a first threshold as the target recommendation content.

In some embodiments of the disclosure, the displaying module 1204 is configured to:
determine a content to be recommended whose similarity with the currently displayed content is less than a second threshold as the target recommendation content; or,
determine a content to be recommended that does not belong to the same type as the currently displayed content as the target recommendation content.

In some embodiments of the disclosure, the apparatus also includes: a second processing module. The second processing module is configured to:
determine a click rate of each recommendation card based on a click rate prediction model;
obtain second interactive information corresponding to the recommendation card;
determine a score of the recommendation card based on the click rate and the second interactive information; and
determine first sample data, in which the first sample data includes the score of the recommendation card, the content to be recommended corresponding to the recommendation card, the description information o f interested content of the target user and the popular search sentences, and the first sample data is configured for performing an update training on the large model.

In some embodiments of the disclosure, the second processing module is configured to:
in response to any content to be recommended corresponding to at least two recommendation cards, determine a recommendation weight corresponding to each of the at least two recommendation cards based on the score of each of the at least two recommendation cards; and
determine second sample data, wherein the second sample data comprises the recommendation card, the recommendation weights corresponding to the recommendation cards, the any content to be recommended, the description information of interested content of the target user and the popular search sentences, and the second sample data is configured for performing an update training on the large model.

In some embodiments of the disclosure, the second processing module is configured to:
determine the second interactive information corresponding to the recommendation card according to clicked information corresponding to the recommendation card and consumed information of a follow-up content of the recommendation card, wherein the follow-up content is a content displayed after clicking the recommendation card.

In some embodiments of the disclosure, the second processing module is configured to:
obtain the click rate by inputting the recommendation in the recommendation card, an behavior sequence of the target user during a second preset time period and a portrait of the target user into the click rate prediction model.

In some embodiments of the disclosure, the apparatus also includes: a third processing module. The third processing module is configured to:
determine third sample data, in which the third sample data includes clicked information corresponding to the recommendation card and consumed information of a follow-up content of the recommendation card, and the third sample data is configured for performing an update training on the click rate prediction model.

It should be noted that the above explanation of the large model-based recommendation method is also applicable to the large model-based recommendation apparatus in this embodiment, and will not be repeated here.

In the embodiment of the disclosure, the description information of interested content corresponding to the target user is determined firstly, and then the content to be recommended, the description information of interested content and the current popular search sentences are input into the large model to generate at least one recommendation card corresponding to the content to be recommended. The current behavior characteristic of the target user is then obtained, and when the current behavior characteristic satisfies the display condition of the recommendation card, the recommendation card corresponding to at least one content to be recommended is displayed. Therefore, for the same content to be recommended, different recommendation cards can be generated for different users in combination with the description information of interested content of different users and the popular search sentences, so that the generated recommendation cards are more likely to comply with user preferences, and the recommendation card can be displayed for the user according to the user's current behavior, which improves a diversity and an accuracy of recommendation ways.

According to the embodiments of the disclosure, the disclosure also provides an electronic device, a readable storage medium and a computer program product.

FIG. 13 is a schematic block diagram of an exemplary electronic device 1300 that can be configured to implement the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable apparatuses, and other similar computing apparatuses. The components shown here, their connections and relations, and their functions are merely examples, and are not intended to limit the implementations of the disclosure described and/or required herein.

As illustrated in FIG. 13, the electronic device 1300 includes a computing unit 1301 for performing various appropriate actions and processes based on computer programs stored in a Read-Only Memory (ROM) 1302 or computer programs loaded from a storage unit 1308 to a Random Access Memory (RAM) 1303. In the RAM 1303, various programs and data required for the operation of the electronic device 1300 are stored. The computing unit 1301, the ROM 1302, and the RAM 1303 are connected to each other through a bus 1304. An input/output (I/O) interface 1305 is also connected to the bus 1304.

A plurality of components in the electronic device 1300 are connected to the I/O interface 1305, including: an input unit 1306, such as a keyboard, a mouse; an output unit 1307, such as various types of displays, speakers; a storage unit 1308, such as a disk, an optical disk; and a communication unit 1309, such as network cards, modems, and wireless communication transceivers. The communication unit 1309 allows the electronic device 1300 to exchange information/data with other devices through a computer network such as the Internet and/or various telecommunication networks.

The computing unit 1301 may be various general-purpose and/or dedicated processing components with processing and computing capabilities. Some examples of the computing unit 1301 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 1301 executes the various methods and processes described above, such as the large model-based recommendation method. For example, in some embodiments, the large model-based recommendation method may be implemented as a computer software program, which is tangibly contained in a machine-readable medium, such as the storage unit 1308. In some embodiments, part or all of the computer programs may be loaded and/or installed on the electronic device 1300 via the ROM 1302 and/or the communication unit 1309. When the computer program is loaded on the RAM 1303 and executed by the computing unit 1301, one or more steps of the above large model-based recommendation method may be executed. Alternatively, in other embodiments, the computing unit 1301 may be configured to perform the large model-based recommendation method in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various implementations may be implemented in one or more computer programs, the one or more computer programs may be executed and/or interpreted on a programmable system including at least one programmable processor, which may be a dedicated or general programmable processor for receiving data and instructions from a storage system, at least one input apparatus and at least one output apparatus, and transmitting the data and instructions to the storage system, the at least one input apparatus and the at least one output apparatus.

The program code configured to implement the method of the disclosure may be written in any combination of one or more programming languages. These program codes may be provided to the processors or controllers of general-purpose computers, dedicated computers, or other programmable data processing apparatuses, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, Electrically Programmable Read-Only-Memories (EPROMs), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display apparatus (e.g., a Cathode Ray Tube (CRT) or a Liquid Crystal Display (LCD) monitor for displaying information to a user); and a keyboard and pointing apparatus (such as a mouse or trackball) through which the user can provide input to the computer. Other kinds of apparatuses may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

In addition, the terms “first” and “second” are only used for description purposes, and cannot be understood as indicating or implying relative importance or implicitly indicating the number of indicated technical features. Therefore, the features defined using the terms “first” and “second” can explicitly or implicitly include at least one of such feature. In the description of this disclosure, “a plurality of” means at least two, such as two, three, etc., unless otherwise specifically defined. In the description of this disclosure, the term “if” and “as” can be interpreted as “when”, “while” “in response to determining” or “in the case of”.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A large model-based recommendation method, comprising:
determining description information of interested content corresponding to a target user;
inputting a content to be recommended, the description information of interested content and current popular search sentences into a large model to generate at least one recommendation card corresponding to the content to be recommended, wherein the recommendation card contains a recommendation word associated with the content to be recommended;
obtaining a current behavior characteristic of the target user; and
in response to the current behavior characteristic satisfying a display condition of the recommendation card, displaying the recommendation card corresponding to at least one content to be recommended.

2. The method of claim 1, wherein before inputting the content to be recommended, the description information of interested content and the current popular search sentences into the large model to generate at least one recommendation card corresponding to the content to be recommended, wherein the recommendation card contains the recommendation word associated with the content to be recommended, and the method further comprises:
obtaining first interactive information of each candidate content in a candidate content library during a first preset time period; and
determining a current content to be recommended from the candidate content library according to the first interactive information of each candidate content.

3. The method of claim 1, wherein in response to the current behavior characteristic satisfying the display condition of the recommendation card, displaying the recommendation card corresponding to at least one content to be recommended, comprises:
in response to the current behavior characteristic satisfying the display condition of the recommendation card, determining a type of the display condition satisfied currently;
determining a target recommendation content based on the type of the display condition satisfied; and
displaying a recommendation card corresponding to the target recommendation content.

4. The method of claim 3, wherein determining the target recommendation content based on the type of the display condition satisfied, comprises:
in response to the type of the display condition being a first type, determining the target recommendation content based on a content currently consumed by the target user; or,
in response to the type of the display condition being a second type, determining the target recommendation content based on a content currently displayed on a display interface.

5. The method of claim 4, wherein determining the target recommendation content based on the content currently consumed by the target user, comprises:
determining a content to be recommended belonging to the same type as the content currently consumed as the target recommendation content; or,
determining a content to be recommended whose similarity with the content currently consumed is greater than a first threshold as the target recommendation content.

6. The method of claim 4, wherein determining the target recommendation content based on the content currently displayed on the display interface, comprises:
determining a content to be recommended whose similarity with the content currently displayed is less than a second threshold as the target recommendation content; or,
determining a content to be recommended that does not belong to the same type as the content currently displayed as the target recommendation content.

7. The method of claim 1, wherein after displaying the recommendation card corresponding to at least one content to be recommended, the method further comprises:
determining a click rate of each recommendation card based on a click rate prediction model;
obtaining second interactive information corresponding to the recommendation card;
determining a score of the recommendation card based on the click rate and the second interactive information; and
determining first sample data, wherein the first sample data comprises the score of the recommendation card, the content to be recommended corresponding to the recommendation card, the description information of interested content of the target user and the popular search sentences, and the first sample data is configured for performing an update training on the large model.

8. The method of claim 7, wherein after determining the score of the recommendation card, the method further comprises:
in response to any content to be recommended corresponding to at least two recommendation cards, determining a recommendation weight corresponding to each of the at least two recommendation cards based on the score of each of the at least two recommendation cards; and
determining second sample data, wherein the second sample data comprises the recommendation card, the recommendation weight corresponding to the recommendation card, the any content to be recommended, the description information of interested content of the target user and the popular search sentences, and the second sample data is configured for performing an update training on the large model.

9. The method of claim 7, wherein obtaining the second interactive information corresponding to the recommendation card, comprises:
determining the second interactive information corresponding to the recommendation card according to clicked information corresponding to the recommendation card and consumed information of a follow-up content of the recommendation card, wherein the follow-up content is a content displayed after clicking the recommendation card.

10. The method of claim 7, wherein determining the click rate of each recommendation card based on the click rate prediction model, comprises:
obtaining the click rate by inputting the recommendation word in the recommendation card, an behavior sequence of the target user during a second preset time period and a portrait of the target user into the click rate prediction model.

11. The method of claim 10, further comprising:
determining third sample data, wherein the third sample data comprises clicked information corresponding to the recommendation card and consumed information of a follow-up content of the recommendation card, and the third sample data is configured for performing an update training on the click rate prediction model.

12. An electronic device, comprising:
a processor; and
a memory for storing instructions;
wherein the processor is configured to perform:
determining description information of interested content corresponding to a target user;
inputting a content to be recommended, the description information of interested content and current popular search sentences into a large model to generate at least one recommendation card corresponding to the content to be recommended, wherein the recommendation card contains a recommendation word associated with the content to be recommended;
obtaining a current behavior characteristic of the target user; and
in response to the current behavior characteristic satisfying a display condition of the recommendation card, displaying the recommendation card corresponding to at least one content to be recommended.

13. The electronic device of claim 12, wherein the processor is further configured to perform:
obtaining first interactive information of each candidate content in a candidate content library during a first preset time period; and
determining a current content to be recommended from the candidate content library according to the first interactive information of each candidate content.

14. The electronic device of claim 12, wherein the processor is further configured to perform:
in response to the current behavior characteristic satisfying the display condition of the recommendation card, determining a type of the display condition satisfied currently;
determining a target recommendation content based on the type of the display condition satisfied; and
displaying a recommendation card corresponding to the target recommendation content.

15. The electronic device of claim 14, wherein the processor is further configured to perform:
in response to the type of the display condition being a first type, determining the target recommendation content based on a content currently consumed by the target user; or,
in response to the type of the display condition being a second type, determining the target recommendation content based on a content currently displayed on a display interface.

16. The electronic device of claim 15, wherein the processor is further configured to perform:
determining a content to be recommended belonging to the same type as the content currently consumed as the target recommendation content; or,
determining a content to be recommended whose similarity with the content currently consumed is greater than a first threshold as the target recommendation content.

17. The electronic device of claim 15, wherein the processor is further configured to perform:
determining a content to be recommended whose similarity with the content currently displayed is less than a second threshold as the target recommendation content; or,
determining a content to be recommended that does not belong to the same type as the content currently displayed as the target recommendation content.

18. The electronic device of claim 12, wherein the processor is further configured to perform:
determining a click rate of each recommendation card based on a click rate prediction model;
obtaining second interactive information corresponding to the recommendation card;
determining a score of the recommendation card based on the click rate and the second interactive information; and
determining first sample data, wherein the first sample data comprises the score of the recommendation card, the content to be recommended corresponding to the recommendation card, the description information of interested content of the target user and the popular search sentences, and the first sample data is configured for performing an update training on the large model.

19. The electronic device of claim 18, wherein the processor is further configured to perform:
in response to any content to be recommended corresponding to at least two recommendation cards, determining a recommendation weight corresponding to each of the at least two recommendation cards based on the score of each of the at least two recommendation cards; and
determining second sample data, wherein the second sample data comprises the recommendation card, the recommendation weight corresponding to the recommendation card, the any content to be recommended, the description information of interested content of the target user and the popular search sentences, and the second sample data is configured for performing an update training on the large model.

20. A non-transitory computer-readable storage medium having computer instructions stored thereon, wherein when the computer instructions are executed by a processor, the processor is caused to perform:
determining description information of interested content corresponding to a target user;
inputting a content to be recommended, the description information of interested content and current popular search sentences into a large model to generate at least one recommendation card corresponding to the content to be recommended, wherein the recommendation card contains a recommendation word associated with the content to be recommended;
obtaining a current behavior characteristic of the target user; and
in response to the current behavior characteristic satisfying a display condition of the recommendation card, displaying the recommendation card corresponding to at least one content to be recommended.
